(19) United States
(12) Patent Application Publication
(10) Pub. No.: US 2004/0216705 A1
(43) Pub. Date: Nov. 4, 2004

(54) Thermal 2 stroke engine with reduced pollution and 4 stroke engine with scavenging and volumetric supercharging

(75) Inventor: Didier Le Bleis, Perpignan (FR)

Correspondence Address: YOUNG & THOMPSON, 745 SOUTH 23RD STREET 2ND FLOOR, ARLINGTON, VA, 22202

(73) Assignees: EURL D.L.D., RIVESLTES (FR); ABEL FRANCO, HALLUIN (FR); PIERRE RIBETTO, PARIS (FR)

(21) Appl. No.: 10/855,627

(22) Filed: May 28, 2004

(30) Foreign Application Priority Data
Apr. 15, 2002 (FR) 02 04698
Apr. 14, 2003 (EP) 03 352008.1

(51) Int. Cl. F02B 33/04

(52) U.S. Cl. 123/65 S

(57) ABSTRACT

The invention relates to a 2 stroke single-cylinder or multi-cylinder engine which improves the scavenging system and its supply. It is formed by two cylinders (10) and (11) forming an annular chamber (5), by a crown piston (6), two fresh gas inlets (4) and (5) and a pure air inlet (2). The principle consists in scavenging the cylinder (10) with pure air in order to evacuate the exhaust gases, avoiding any contact with the fresh gases, whilst improving the supply. The invention is particularly intended for small cylinders. Its application to the 4 stroke engine requires use of a special piston (D3), moving in an adapted cylinder formed by two elements numbered (D8) and (D9), forming with the piston an annular chamber (D1). This type of piston allows better filling of the cylinder and better evacuation of the exhaust gases by propelling pure air into the cylinder. The invention is intended for large capacity diesel or petrol 2 or 4 stroke engines.

The invention aims to reduce the pollution of 2 stroke engines and to improve the filling thereof with fresh gases. The device according to the invention comprises essentially a crown piston moving in a standard cylinder where an annular chamber is machined which the crown of the piston divides into 2 variable volumes (5) and (2), according to its position. The skirt of the piston is long in order to ensure sealing of the annular chamber (2) by means of a lower segment. In this chamber, pure air and the mixture of fresh gases are drawn-in, compressed then expelled alternately. The device is characterised in that the pure air transfer ports (2b) are uncovered by the piston before the fresh gas transfer ports (4b). A single carburettor can supply the chamber (5) and the pump crankcase with fresh gases, by connecting their 2 intake pipes into a single one via an exterior-manifold (in dotted lines in the drawing). The lower cylinder (11) is dismantleable in order to allow assembly of the piston. The lubrication of the annular chamber is produced by the mixture of fresh gases. The following device is characterised in that the piston comprises 4 segments, 1 of which is on the cap, 2 on the crown and 1 on the skirt, this being optional, the pressures existing between the pump crankcase (4) and the chamber (2) equalising by opposition.

A) The compressed pure air is intended to expel the exhaust gases; it scavenges the cylinder and precedes the arrival of the fresh gases. Its passage, interposed between exhaust gas and fresh gas allows these to avoid being mixed as in a standard 2 stroke engine; as a result, better combustion, therefore greater efficiency and reduced pollution. This system associated with an exhaust, the pressure wave of which, reflected towards the cylinder, as in a standard engine, allows <<blocking of the exit>> by blocking this pure air in the exhaust port, thus avoiding the escape of fresh gases towards the atmosphere.

B) The mixture of fresh gases is precompressed and transferred into the pump crankcase at the end of the intake, thus completing its filling, the power and the efficiency are considerably increased. This system is suitable for all combustion engines which operate according to the 2 stroke cycle, single-cylinder or multi-cylinder, spark ignition and diesel. The operating principle, illustrated by the figures numbered from 1 to 4, is described hereafter.

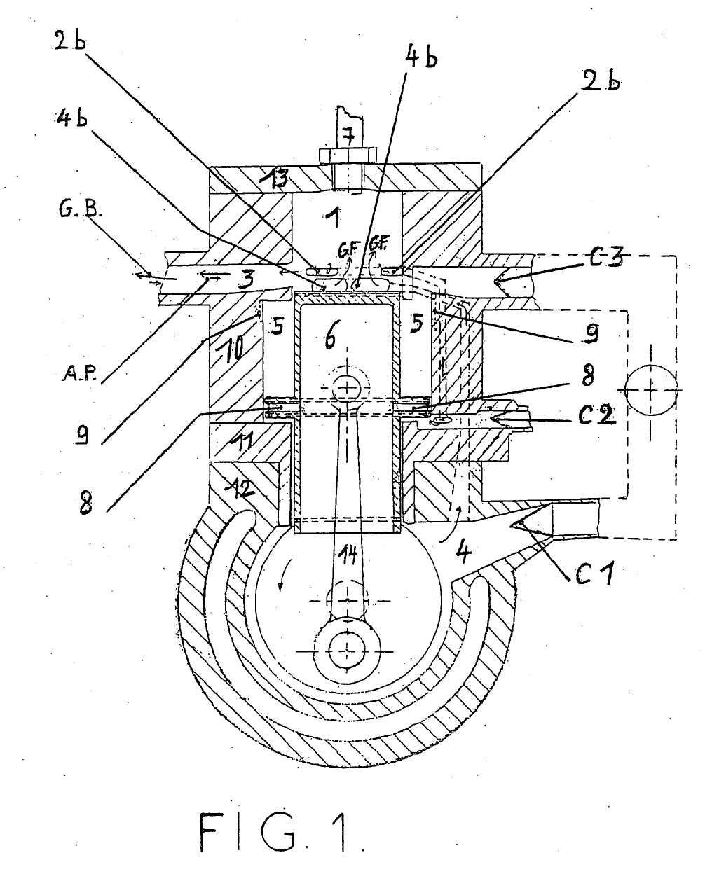

FIG. 1

At bottom dead centre, the piston (6) allows, by freeing the ports, the transfer into the cylinder of the fresh gases precompressed in (4) in the pump crankcase.

Simultaneously, the intake of the fresh gas mixture terminates in (5).

The inlet valves (C3) of the chamber (5) are closed, the pressures downstream and upstream of these valves (C3) equalise, the pure air inlet valves (C2) of the chamber (2) are closed. The inlet valves (C1) for the fresh gas mixture from the pump crankcase (4) are closed. A pure air lock represented by the arrow (AP) obstructs the exhaust port (3) under the effect of the return pressure wave from the exhaust (arrow GB). The fresh gases (arrow GF) can no longer be mixed with the exhaust gases (GB) and invade the combustion chamber (1) by forcing back the pure air.

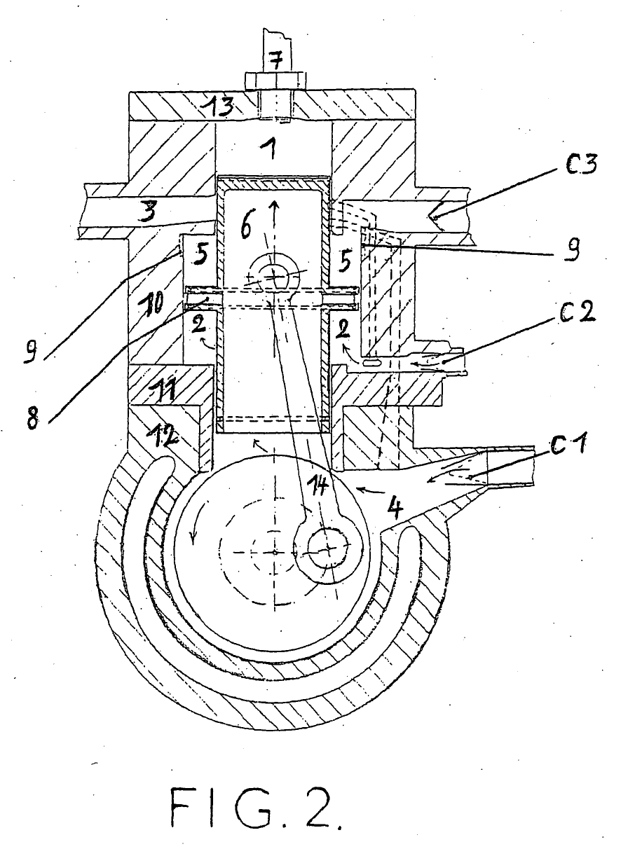

FIG. 2

In the course of its rising in the cylinder, the piston (6) compresses the fresh gases in (1), creates a low pressure in (2) and (4), causing the corresponding opening of the valves (C1) and (C2) and therefore the filling of the chamber (2) with pure air, and the pump crankcase (4) with a fresh gas mixture.

Simultaneously, it precompresses the fresh gases admitted previously into the chamber (5), its valves (C3) being closed under the effect of the pressure.

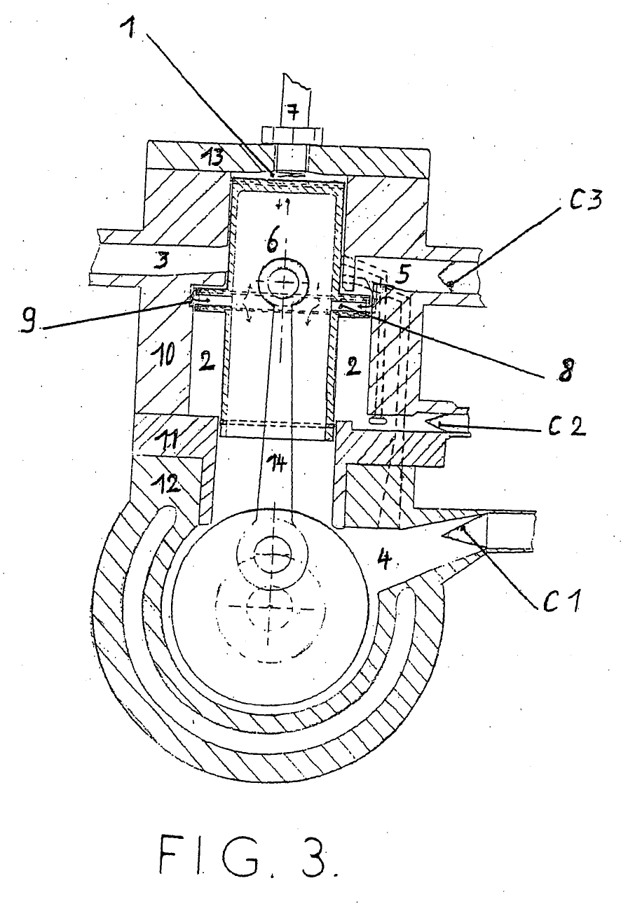

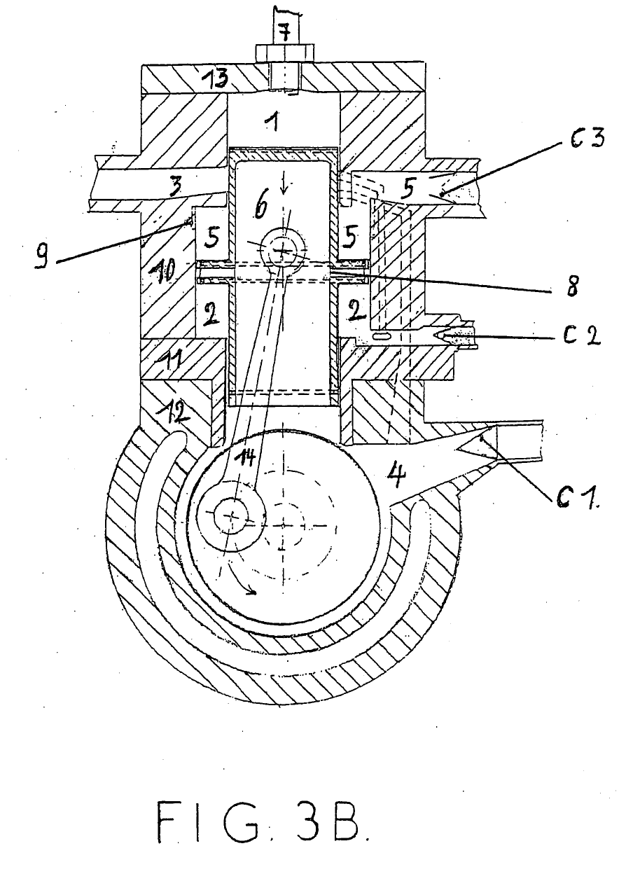

FIG. 3

At top dead centre, the ignition initiated by the spark plug (7) ignites the compressed fresh gases in (1) initiating the power stroke of the piston (6). The intake of pure air is terminated in (2), the valves (C2) of this chamber are closed, the low pressure having disappeared. In (4), the filling of the fresh gas mixture from the pump crankcase is likewise terminated by the valves (C1) which have closed again under the effect of the pressure of the fresh gases which were precompressed in the chamber of the cylinder (5) and transferred via the ports (8) of the piston crown (6) and ports (9) of the cylinder. The supply is therefore optimal, the volume of the chamber (5) being added to that of the pump crankcase (4).

FIG. 3B

The piston (6) descends under the thrust of the gases which expand in (1). The ports (8) of the crown and (9) of the cylinder no longer communicate; low pressure follows in the chamber (5) which initiates the opening of its valves (C3) and the filling of this chamber with the fresh gas mixture.

Simultaneously the pure air previously admitted in (2) is compressed, the valves (C2) of this chamber being kept closed by this same pressure. The fresh gases previously admitted into the pump crankcase (4) are likewise in precompression.

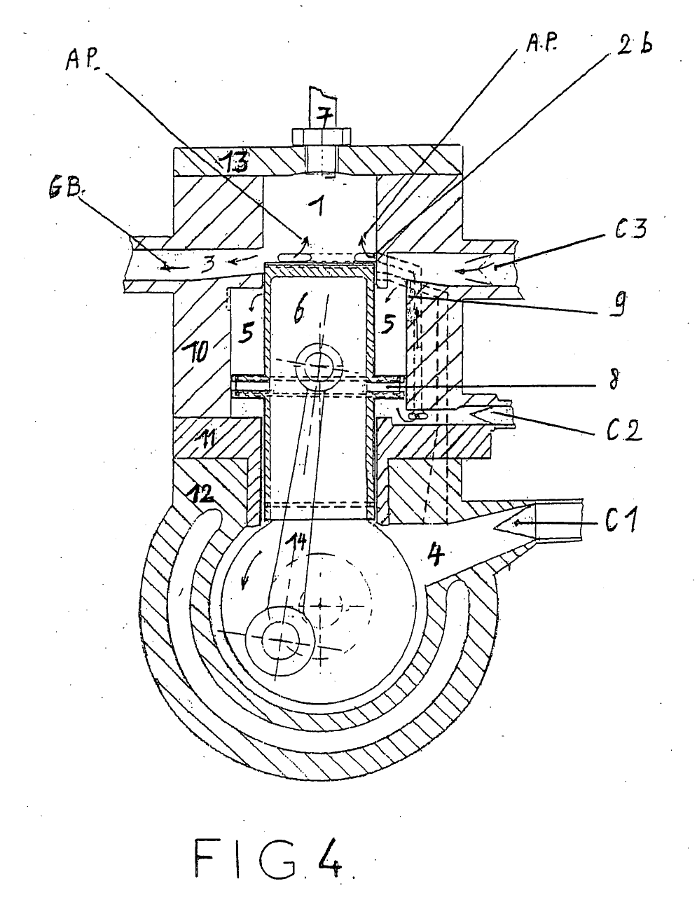

FIG. 4

At the end of the power stroke, the piston (6) successively frees:

1) The exhaust port (3) via which the evacuation of exhaust gases commences.

2) The transfer ports (2b) allowing the introduction of compressed pure air in (2) which forces back the exhaust gases towards the exhaust port (3) and scavenges the combustion chamber (1).

3) The corresponding transfer ports (4b) (see FIG. 1) to the fresh gas mixture precompressed in the pump crankcase (4). And the cycle is repeated. The number, the shape and placing of various transfers can vary as in all 2 stroke engines. It is immaterial as far as the volume of the annular chamber and of the crown piston is concerned. Pure air can be admitted into the annular chamber (2) after passage through an air filter.

4 STROKE ENGINE

The invention applied to the 4 stroke engine improves the evacuation of the exhaust gases in the exhaust phase. The combustion chamber is scavenged by pure air under pressure penetrating through the transfer ports, forcing back the exhaust gases into the atmosphere via the exhaust valve before itself being forced back by the piston.

In the intake phase, the fresh gases admitted by the inlet valve into the combustion chamber are supplemented passing through bottom dead centre by an arrival of pure air under pressure spurting from the transfer ports, thus ensuring optimal filling of the cylinder.

The invention allows improvement of the cleanness, the power and the efficiency of spark ignition and diesel 4 stroke engines. It is characterised by a crown piston (D3) moving in a cylinder (D8) and a cylinder (D9), forming with the latter an annular chamber (D1) admitting pure air by means of valves (C19) during the rising of the piston (D3) and compressing it during its descent, then transferring it into the combustion chamber (D2), the cap of the piston (D3) uncovering the transfer ports (T1) just before passing through bottom dead centre, thus allowing better filling of the cylinder in the intake phase and an improvement in the evacuation of the exhaust gases in the exhaust phase. The diameter of the skirt of the piston, which has a sealing segment at its base, is less than the diameter of the piston head which itself has 2 or 3 segments. The cylinder (D8) is completed by a cylinder of a lesser diameter (D9), in which the skirt of the piston (D3) slides, forming with the latter an annular precompression chamber. The transfer ports (T1) are uncovered by the piston in the exhaust phase after the opening of the exhaust valve. The compression chamber for pure air, through an air filter, communicates with the atmosphere by means of valves regulating its supply.

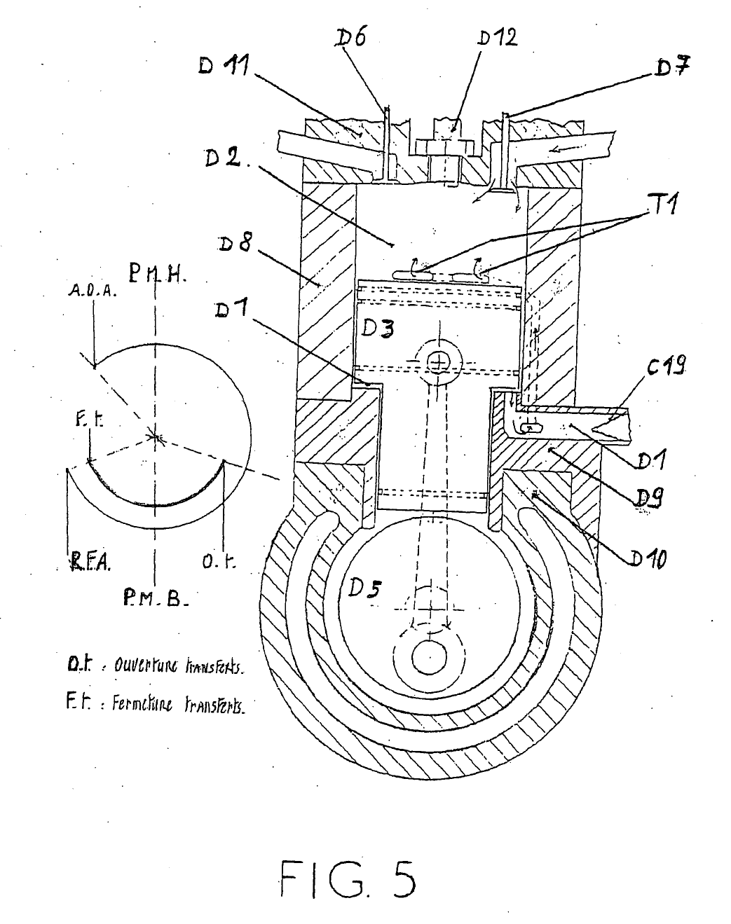

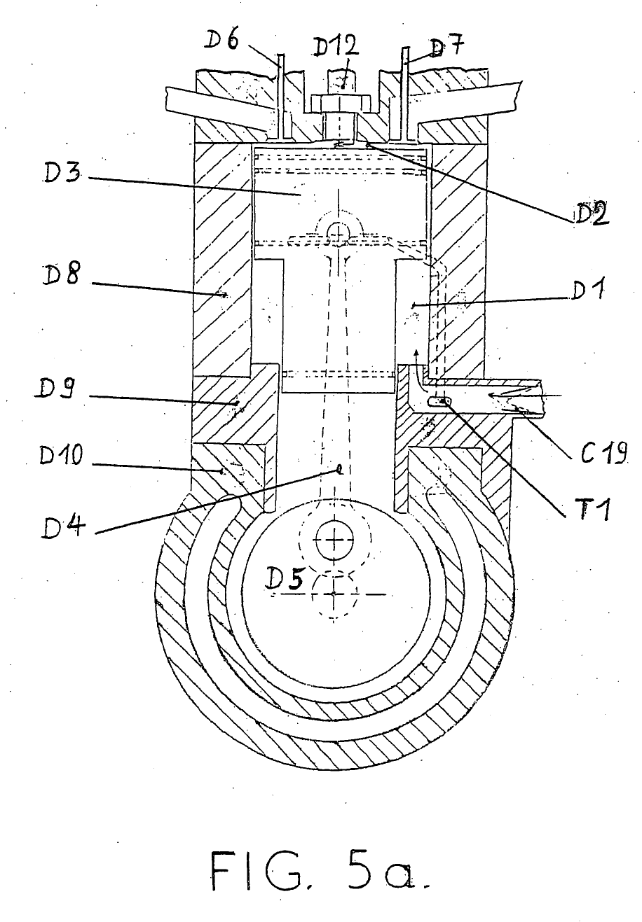

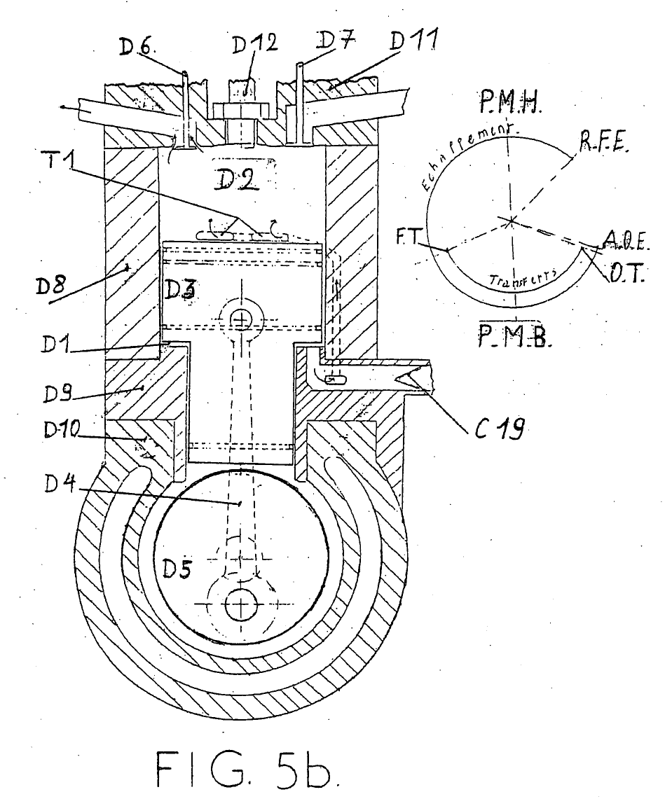

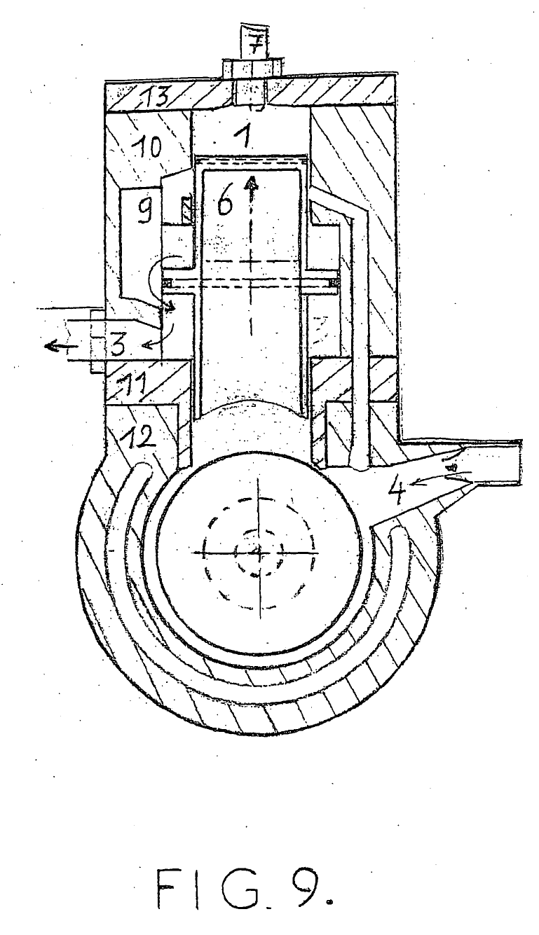

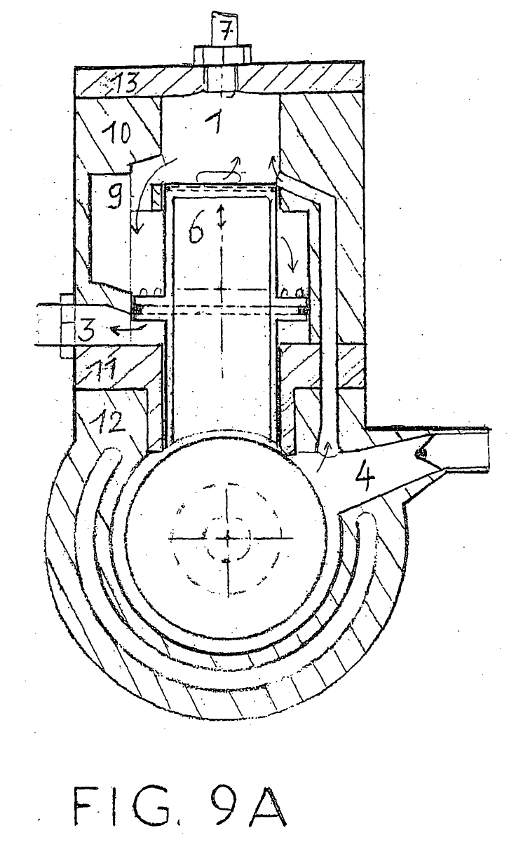

The operating principle, illustrated by FIGS. 5, 5a and 5b is described below.

FIG. 5

Whilst passing bottom dead centre, the piston (D3) uncovers the transfer ports (T1) allowing compressed pure air in (D1) to invade the combustion chamber (D2) and complete the intake of fresh gases penetrating via the then open inlet valve (D7).

FIG. 5A The exhaust valves (D6) and inlet valves (D7) are closed. The previously admitted fresh gases are compressed in (D2). The piston (D3) whilst rising creates low pressure in (D1), opening the valves (C19) and allowing the filling of the annular chamber (D1) with pure air.

FIG. 5B

The piston, at the end of the power stroke, uncovers the ports (T1); the compressed air in (D1) penetrates into the combustion chamber (D2) and forces back the exhaust gases into the atmosphere through the exhaust valve (D6) which is already open. The piston, in the course of rising, terminates the evacuation of the exhaust gases and the pure air. The number, the shape, the placing of the transfer ports can vary with the objective of obtaining maximum efficiency by modifying the distribution diagrams. It is immaterial as far as the volumes of the annular chamber and of the crown piston are concerned. The device can be used as an air compressor in 4 stroke engines, it is therefore characterised by a crown piston (D3) moving in a cylinder (D8) and a cylinder (D9), forming with the latter an annular chamber (D1) admitting pure air by means of valves (C19) during the rising of the piston (D3), and compressing it during its descent in order to supply an exterior reservoir provided with a non-return valve, by means of transfer passages discharging into an exterior channel system supplying this reservoir, the engine then operating like a standard engine, and the invention like an integrated air compressor.

### PARTS LIST

1 Combustion chamber

2 Annular pure air chamber

3 Exhaust outlet

4 Pump crankcase

5 Annular fresh gas chamber

6 Crown piston

7 Spark plug

8 Crown piston port

9 Transfer passage of the cylinder

10 Engine upper cylinder

11 Lower cylinder

12 Low engine crankcase

13 Cylinder head

14 Connecting rod

2b Pure air transfer port

4b Fresh gas transfer port

C1-C3 Fresh gas valves

C2 Pure air valves

GB Exhaust gases

AP Pure air

GF Fresh gases

D1 Annular chamber

D2 Combustion chamber

T1 Transfer ports

D3 Piston

D4 Connecting rod

D5 Crankshaft

D6 Exhaust valve

D7 Inlet valve

C19 Valves

D8 Cylinder

D9 Lower cylinder

D10 Low engine crankcase

D11 Cylinder head

D12 Spark plug (or injector. Diesel)

### DEVELOPMENT

The modifications introduced to the invention are aimed essentially at reducing the noise, the pollution and the consumption thereof according to an operating principle which is different from the former 2 stroke engine with a crown piston.

The piston differs from the first model by its single crown devoid of ports which is fitted or not with a segment, according to the chosen option. It moves in an adapted cylinder comprising, in its lower portion, an annular chamber in which transfers are machined, which are intended for the evacuation of exhaust gases controlled by the crown of the piston, which, at bottom dead centre, retains these gases in this chamber, which is sufficiently voluminous to reduce their pressure and to allow the intake into the combustion chamber of fresh gases precompressed in the pump crankcase of the engine then, in the course of its rising, retains these fresh gases in the combustion chamber by means of the exhaust gases, which are freed into a determined zone for better efficiency of the engine, just before or just after the closure of the exhaust port of the combustion chamber, via the piston cap, in order to be discharged with force into the atmosphere during a descending phase.

The power stroke of the piston is prolonged until bottom dead centre via the transfer of exhaust gases into the annular chamber where they apply pressure on the crown which forces back, via its lower face, the gases of the preceding combustion towards the atmosphere.

The sound wave emitted by the combustion of the gases in the power stroke is retained in the annular chamber where it is damped, the transfer of the exhaust gases towards the atmosphere being achieved indirectly.

In the case of petrol injection and diesel 4 stroke engines, the intake of pure or fuel-injected air can be effected entirely by the valves and transferred into the cylinder by the ports of the transfers which are uncovered by the piston cap when passing through bottom dead centre, thus allowing the inlet valve or valves with the supply thereof to be dispensed with, therefore simplifying the engine and reducing the manufacturing costs.

The efficiency is increased by better filling of the cylinder which, in the intake phase is at low pressure until opening of the ports communicating with the lower cylinder of the piston-pump which, then in compression, propels the pure or fuel-injected air into the combustion chamber, allowing an optimal intake speed and optimal filling.

In the exhaust phase, the combustion is improved by the pure air propelled into the combustion chamber, as above, it scavenges the cylinder and assists oxidation of the gases. This piston-pump system is likewise suitable for diesel and 2 stroke petrol engines as it is able to send a sufficient volume of air into the combustion chamber without the help of a compressor or valves whilst preserving the standard lubrication system under pressure for 4 stroke engines.

1. Device allowing a reduction in pollution and an increase in the efficiency and power of combustion engines operating according to the 2 stroke cycle, by carburation or injection, including a crown piston (6) moving in a cylinder (1) comprising, in its lower portion, an annular chamber which the crown of the piston divides into 2 variable volumes (5) and (2) according to its position, the crown of the piston being provided with ports (8) communicating with transfer passages (9) starting at the approach of top dead centre, the fresh gas mixture being admitted into the variable volume (5) of the annular chamber by means of valves (C3) opening via low pressure during the descent of the piston, compressed during its rising then transferred into the volume (4) of the pump crankcase via the transfer passages (9) and the ports (8), the pump crankcase (4) comprising other valves (C1) for admitting the fresh gas mixture, the pure air being admitted into the variable volume (2) of the annular chamber by means of valves (C2) opening via low pressure during the rising of the piston, compressed during its descent then transferred into the combustion chamber (1) via the ports (2b) uncovered by the cap of the piston just before bottom dead centre, the fresh gases themselves being transferred into the combustion chamber via the transfer passages discharging into the combustion chamber via ports (4b) situated in the vicinity of bottom dead centre of the stroke of the piston.

2. Device according to claim 1, wherein the piston comprises 4 segments, 1 of which is on the cap, 2 on the crown and 1 on the skirt, this being optional, the pressures existing between the pump crankcase (4) and the chamber (2) equalising by opposition.

3. Device according to claim 1, further comprising a long piston (6), the skirt of the long piston serving for sealing the annular chamber (2) by means of the lower segment.

4. Device according to claim 1, wherein the pure air transfer ports (2b) are uncovered by the piston before the fresh gas transfer ports (4b).

5. Device according to claim 1, wherein the lubrication of the annular chamber is achieved by the mixture of fresh gases as in a standard 2 stroke engine.

6. Device according to claim 1, wherein a single carburettor can supply the chamber (5) and the pump crankcase (4) with fresh gases, by connecting their 2 intake pipes into 1 single pipe via an exterior manifold (in dotted lines in the drawing).

7. Device according to claim 1, wherein the low cylinder (11) which is dismantleable in order to allow assembly of the piston.

8. Device allowing a reduction in the pollution and an increase in the efficiency and power of combustion engines operating according to the 4 stroke cycle by carburation or injection, and provided with inlet valves (D7) and exhaust valves (D6), by wherein a crown piston (D3) moving in a cylinder (D8) and a cylinder (D9), forming with the latter an annular chamber (D1) admitting pure air by means of valves (C19) during the rising of the piston (D3) and compressing it during its descent, then transferring it into the combustion chamber (D1), the cap of the piston (D3) uncovering the transfer ports (T1) just before passing through bottom dead centre, thus allowing better filling of the cylinder in the intake phase and, in the exhaust phase, improving the evacuation of exhaust gases.

9. Device according to claim 8, further comprising an upper cylinder (D8) and a lower cylinder (D9) of a lesser diameter, in which an adapted crown piston (D3) moves, which uncovers in the combustion chamber (D2), at each passage through bottom dead centre, transfer ports (T1) corresponding to the pure air precompression chamber (D1), the pure air being admitted into the annular chamber (D1) of variable volume by means of valves (C19) opening under the effect of the low pressure created by the rising of the piston (D3) in the cylinder, this pure air being compressed during the descent of the piston until the opening of the transfer ports (T1) which the piston uncovers just before bottom dead centre.

10. Device according to claim 8, wherein the diameter of the skirt of the piston, which has a sealing segment at its base, is less than the diameter of the head of the piston which itself has 2 or 3 segments.

11. Device according to claim 8, wherein the cylinder (D8) is completed by a cylinder of a lesser diameter (D9), in which the skirt of the piston (D3) slides, forming with the latter an annular precompression chamber.

12. Device according to claim 8, wherein the transfer ports (T1) are uncovered by the piston in the power stroke phase after the opening of the exhaust valve.

13. Device according to the claim further comprising a pure air compression chamber which, through an air filter, communicates with the atmosphere by means of valves regulating its supply.

14. Device which is able to be used as an air compressor in 4 stroke engines, supplied by carburation or injection, further comprising a crown piston (D3) moving in a cylinder (D8) and a cylinder (D9), forming with the latter an annular chamber (D1) admitting pure air by means of valves (C19) during the rising of the piston (D3), and compressing it during its descent in order to supply an exterior reservoir provided with a non-return valve, by means of transfer passages discharging into an exterior channel system supplying this reservoir, the engine then operating like a standard engine, and the invention like an integrated air compressor.

15. Device allowing a reduction in noise pollution, pollution and consumption, further comprising a long piston, with a single crown devoid of ports, moving in an adapted cylinder comprising, in its lower portion, an annular chamber, in which transfers are machined, which are intended for the evacuation of exhaust gases controlled by the piston crown, and which, at bottom dead centre, retains the exhaust gases expanded in the lower cylinder, which is sufficiently voluminous to cause the pressure to drop and to allow the intake into the combustion chamber of fresh gases precompressed in the pump crankcase, whilst avoiding any losses, then, in the course of its rising, retains the fresh gases in the combustion chamber by means of the exhaust gases before freeing them at the moment when the piston cap closes the exhaust port of the combustion chamber and forcing them back forcefully into the atmosphere, in the descending phase of the piston, via the crown which prolongs the power stroke of the piston until bottom dead centre.

16. Device according to claim 1, wherein the piston comprises 1 or 2 segments on the cap and 1 on the crown, this being optional.

17. Device according to claim 1, further comprising a long piston fitted with a crown which is devoid of transfers in its centre, the diameter of which is calculated to obtain a sufficient volume to reduce the pressure of the exhaust gases in the combustion chamber.

18. Device according to claim 1, wherein the evacuation of the exhaust gases towards the atmosphere begins just before or just after the closure of the exhaust port of the combustion chamber by the piston cap, taking into account that this moment is determined in the zone where the best efficiency of the motor is situated.

19. Device according to claim 1, further comprising an annular chamber provided with an exhaust outlet at its base and with transfers allowing the evacuation of exhaust gases, taking into account the moment of closure of the exhaust port of the combustion chamber by the piston cap.

20. Device according to claim 1, wherein the exhaust gases are discharged into the atmosphere indirectly, after having been reduced in pressure in the annular chamber by prolonging the power stroke of the piston until bottom dead centre.

21. Device according to claim 1, wherein the sound wave emitted by the combustion in the power stroke is retained in the annular chamber where it is suppressed, the transfer of exhaust gases being achieved indirectly.

22. Device according to claim 1, wherein the crown of the piston, during its rising, retains the fresh gases in the combustion chamber by means of the exhaust gases until closure of the exhaust port of the combustion chamber by the piston cap, thus preventing any escape of fresh gases into the atmosphere, moreover reducing pollution and consumption.

23. Device allowing, in petrol injection and diesel 4 stroke engines, filling of the cylinder with pure or fuel-injected air without inlet valves, the volume of admitted air being directly determined by the differences in diameters and the stroke of the piston, these dimensions being calculated for optimum operation of the engine and allowing, in the exhaust phase, an improvement in the scavenging of the cylinder and oxidation of the gases by making pure air available.

24. Device according to claim 9 allowing a reduction in the manufacturing costs by dispensing with the inlet valve or valves and the supply thereof.

25. Device according to claim 9 allowing an optimal intake speed and optimal filling of the cylinder, the latter being at low pressure until the opening of the intake transfers, which are subjected to overpressure via the descent of the piston.

26. Device suitable for 2 stroke diesel and petrol engines as it is able to send a sufficient volume of air into the combustion chamber, with neither compressor nor valve, whilst preserving the standard lubrication system under pressure of 4 stroke engines.
